(19) United States
(12) Patent Application Publication
(10) Pub. No.: US 2015/0066893 A1
(43) Pub. Date: Mar. 5, 2015

(54) SYSTEMS AND METHODS FOR ATTRIBUTING PUBLISHERS FOR REVIEW-WRITING USERS

(71) Applicant: Tune, Inc., Seattle, WA (US)

(72) Inventor: Niek Sanders, Seattle, WA (US)

(21) Appl. No.: 14/473,991

(22) Filed: Aug. 29, 2014

Related U.S. Application Data
(60) Provisional application No. 61/872,539, filed on Aug. 30, 2013.

(51) Int. Cl. G06F 17/30

(52) U.S. Cl. CPC G06F 17/3089; G06F 17/30289; G06F 17/30864
USPC 707/709; 707/803

(57) ABSTRACT

Methods and systems for tracking end users who submit reviews are provided. In some embodiments, reviews are submitted by end users via a reviewing application that reports review submission to a tracking system. In some embodiments, reviews are reported to the tracking system by review web sites that receive the reviews. In some embodiments, the tracking system uses a web crawler to retrieve review information from review web sites. User click records are used to attribute user acquisition to ad providers, and an amount of a reward granted for acquiring a given user may be altered based on records of reviews submitted by the given user.

### CROSS-REFERENCE TO RELATED APPLICATION

This application claims the benefit of U.S. Provisional Application No. 61/872539, filed Aug. 30, 2013, the entire disclosure of which is hereby incorporated by reference herein for all purposes.

### BACKGROUND

Many online advertisers provide rewards to third parties who display advertisements to visitors of their websites and/or users of their software applications, particularly mobile software applications or “apps.” For example, many advertisers pay such third parties whenever an end user “clicks” or otherwise interacts with an advertisement and/or purchases the advertised product. However, advertisers most desire to acquire influential end users who can drive additional traffic to their web site or application, and/or drive additional purchases of their application or product.

In some cases, such as when the subject matter of an advertisement is a mobile or web application, it is desirable to know if an acquired user writes online reviews about the application. Likewise, if the subject matter of an advertisement is a product or physical space (e.g. a toy, consumer electronics product, a car, a restaurant, a bar, a salon, etc.), it is useful to know if an acquired user writes online reviews of the product or space. Unfortunately, currently available methods of tracking downloads, installations, and usage of software applications are not able to track which end users write reviews, and advertisers' ability to target advertising and compensate differently for acquisition of particularly influential users is therefore limited.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an exemplary embodiment of a tracking ecosystem 100 according to various aspects of the present disclosure;

FIG. 2 is a block diagram that illustrates details of some elements of an exemplary embodiment of the ecosystem 100 illustrated in FIG. 1;

FIGS. 3A-3B are a flowchart that illustrates an exemplary embodiment of a method 300 of finding and tracking user reviews according to various aspects of the present disclosure; and

FIG. 4 is a diagram of hardware and an operating environment in conjunction with which implementations of the one or more computing devices of the system 100 may be practiced according to various aspects of the present disclosure.

### DETAILED DESCRIPTION

### Tracking System Overview

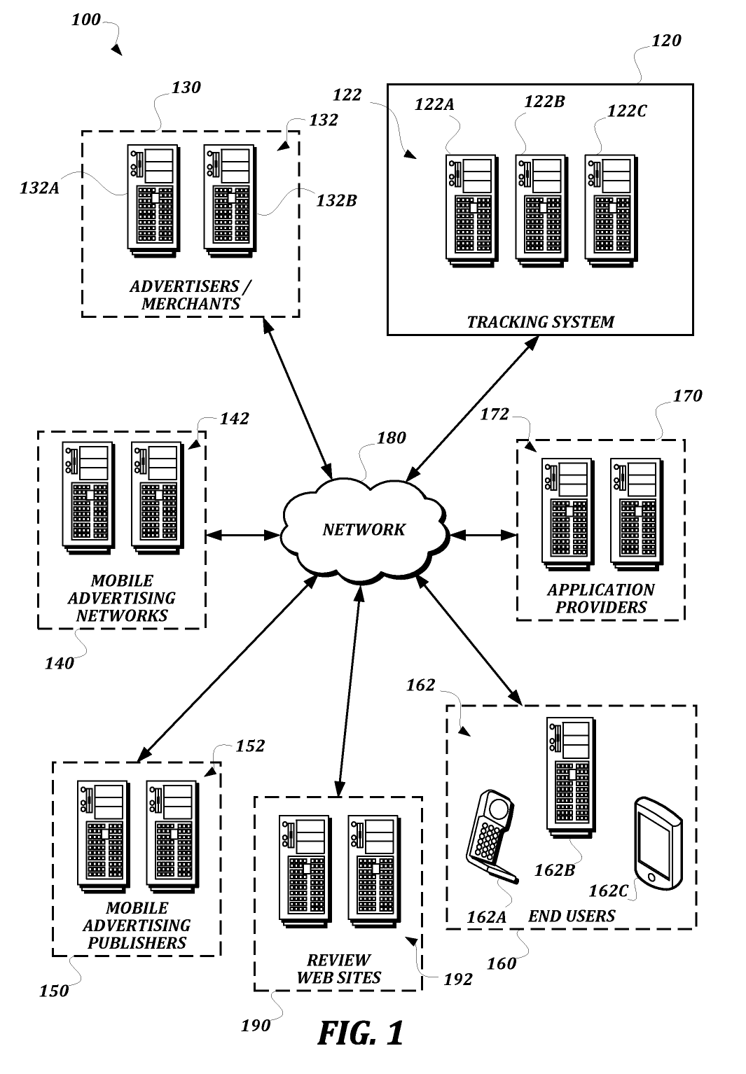

FIG. 1 is a schematic diagram that illustrates an exemplary embodiment of a tracking ecosystem 100 according to various aspects of the present disclosure. The tracking ecosystem 100 may be configured to match interactions with (e.g., clicks on) advertisements with subsequent installations and usage of applications associated with the selected advertisements. This matching may allow such actions may be attributed to the appropriate party or parties that provided (e.g., distributed and/or displayed) the selected advertisements to those who interacted with the advertisements and installed the applications. The tracking ecosystem 100 may also be configured to extract information from reviews posted by tracked end users. The information extracted from reviews may then allow a value to be placed on the tracked end user, and a reward provided for the attribution of the actions to be altered accordingly.

As illustrated, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

The system 100 also includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, one or more computing devices 172 operated by one or more Application Providers 170, and one or more computing devices 192 operated by one or more review web sites 190.

As is apparent to those of ordinary skill in the art, in some embodiments, a single entity may function as one of the Advertisers/Merchants 130, one of the Mobile Advertising Networks 140, and one of the Mobile Advertising Publishers 150, even though they are illustrated in FIG. 1 as separate entities. Such an entity may operate one or more computing devices (not shown) that perform the functions of the computing devices 132, 142, and 152.

The Advertisers/Merchants 130 include companies that wish to advertise products (e.g., software applications) and/or services. As is apparent to those of ordinary skill in the art, to receive some services, the computing devices 162 may be required to install one or more software applications.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and interact with advertisements, such as those created by the Advertisers/Merchants 130, distributed by the Mobile Advertising Networks 140, and/or displayed by the Mobile Advertising Publishers 150. The End Users 160 also use the computing devices 162 to purchase, download, install, and/or interact with applications provided by the Application Providers 170.

The Application Providers 170 include companies that provide installable applications (such as those advertised by the Advertisers/Merchants 130) to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage.

The Review Web Sites 190 include web sites that allow end users 160 to submit reviews of products, services, and/or the like. Some non-limiting examples of review web sites 190 include Yelp (which allows users to post textual reviews and/or provide star ratings of restaurants, stores, home services, and/or the like), Amazon (which allows users to post reviews and ratings of products purchasable through the web site), Angie's List (which allows users to post textual reviews and/or letter grades of home improvement contractors), Hotels.com (which allows users to post textual reviews and number ratings for various categories of service at hotels), and/or the like. In some embodiments, an application provider 170 may provide a server that operates as a review web site 190 as well. For example, an app store may collect ratings of the apps made available thereon, and the app store may make these ratings available via a review web site 190.

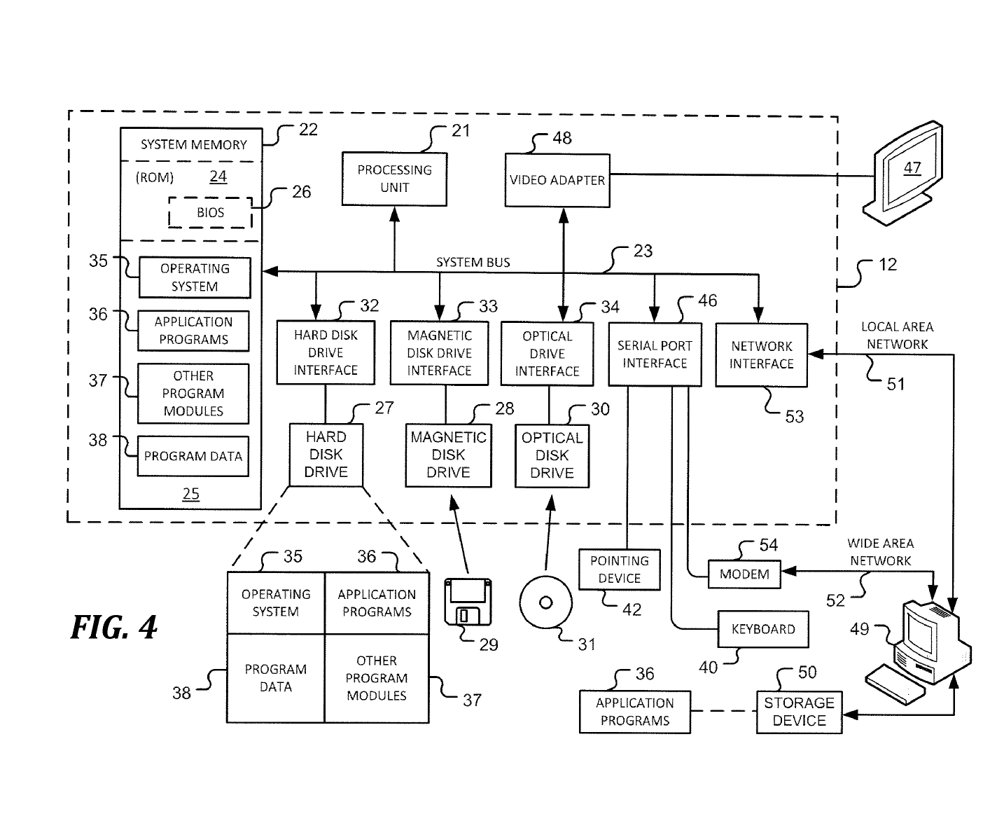

The computing devices 122, 132, 142, 152, 162, 172, and 192 are connected to one another by a network 180 (e.g., the Internet). Each of the computing devices 122, 132, 142, 152, 162, 172, and 192 may be implemented using a computing device similar to the computing device 12 illustrated in FIG. 4 and described below. By way of non-limiting examples, the computing devices 162 have been illustrated as including a cellular telephone 162A, a personal computer 162B (e.g., a desktop computer), and a tablet computer 162C. Each of the computing devices 162 may be configured to implement an advertisement displaying application, such as an Internet browser application, and/or a different application configured to display advertisements.

### Tracking User Reviews

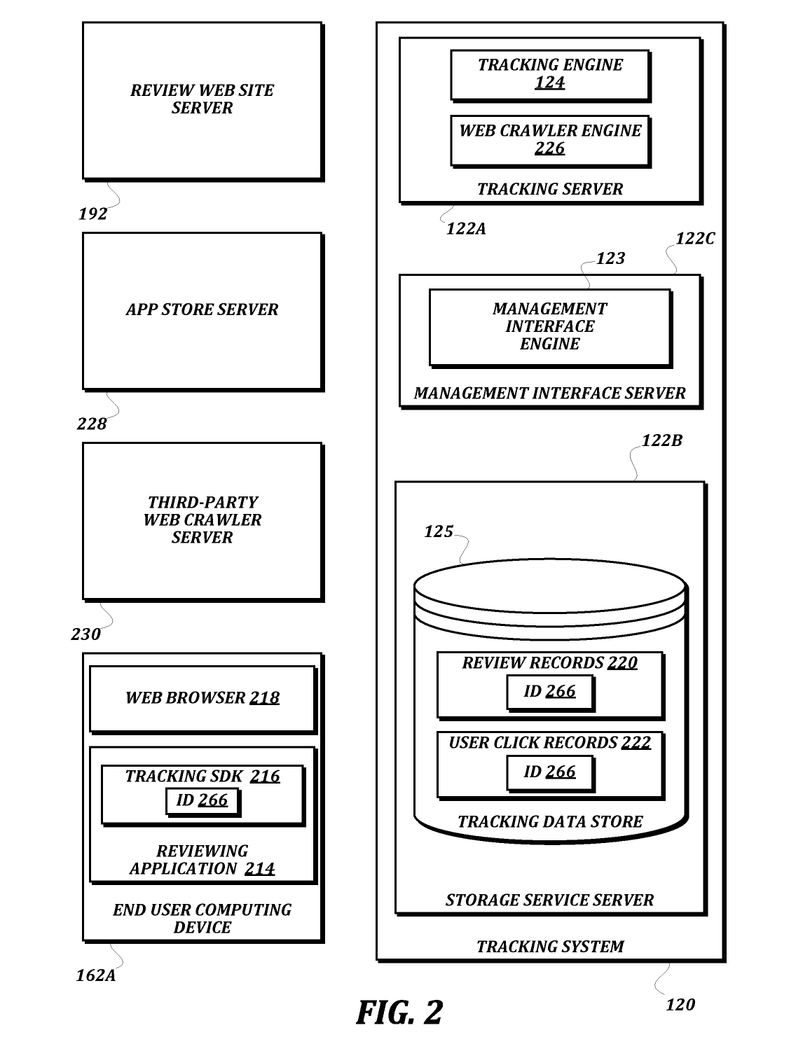

FIG. 2 is a block diagram that illustrates details of some elements of an exemplary embodiment of the ecosystem 100 illustrated in FIG. 1. The tracking server 122A is configured to provide a tracking engine 124 and a web crawler engine 226. In general, the term “engine” as used herein refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine. The tracking engine 124 is configured to communicate with the storage service server 122B. The web crawler engine 226 is configured to retrieve information from review web site servers 192 and/or app store servers 228, and to provide the retrieved information to the tracking engine 124.

The storage service server 122B is configured to provide a tracking data store 125 that stores tracking, installation, and review information received from the tracking server 122A and/or the management interface server 122C. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, the tracking data store 125 is configured to store at least a set of user click records 222 and a set of review records 220. In some embodiments, each of the review records 220 and user click records 222 may be associated with a tracking identifier 266. The tracking identifier 266 may be used to associate the stored records with a particular user and/or a particular end user computing device 162.

In some embodiments, the tracking identifier 266 may be generated and assigned to the user or the end user computing device 162 by the tracking system 120. In some embodiments, the tracking identifier 266 may include device information that comprises at least one device identifier and/or other information associated with one of the computing devices 162 (see FIG. 1) that was not assigned by the tracking system 122. In some embodiments, the tracking identifier 266 may also be associated with a user name, account name, email address, or other identifier that can be used to identify the user of the computing device 162. The device identifiers may be assigned to the computing devices 162 to uniquely identify the computing devices 162, and may therefore be used by the tracking system 122 to uniquely identify the end user computing device 162 or the user thereof

Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), combinations thereof, and the like. By way of a non-limiting example, the IMEI may be an Android IMEI. By way of another non-limiting example, the MEID may be an Android MEID.

The other information associated with one of the computing devices 162 may include an Internet Protocol (“IP”) Address, browser information (e.g., browser type, browser version, etc.), combinations thereof, and the like. The other information may be usable to identify a computing device 162, though the other information may be less reliable for uniquely identifying a computing device 162 than the device identifiers. Optionally, all or a portion of the device information may be hashed instead of being stored directly in plain text in the tracking identifier 266.

In some embodiments, the user click records 222 may indicate user interactions with advertisements provided by mobile advertising publishers 150, and may be associated with other records to attribute actions taken by a user to the advertising publishers 150 that encouraged the action. Further details regarding how user click records may be used to attribute actions to advertising publishers 150 and provide credit for doing so may be found in commonly owned, co-pending U.S. patent application Ser. No. 13/902,691, filed May 24, 2013, the entire disclosure of which is hereby incorporated by reference for all purposes.

In some embodiments, the review records 220 may include records that represent reviews submitted by the users tracked by the user click records 222. Each review record may include information about the review, including but not limited to device identifiers, user identifiers, tracking identifiers, a type of review (e.g., text review, star rating review, upvote/downvote review, affinity indicator, and/or the like), review text, review polarity (positivity or negativity) of the review, quality of the review (e.g., length, completeness, reading level of language used, and/or the like), a timestamp of the review, confirmation that the reviewing user purchased and/or used the subject matter of the review, and/or the like. In some embodiments, the tracking identifier 266 may be included to match the review records 220 to the user click records 222. In some embodiments, the review records 220 may include a match probability that indicates a predicted likelihood that the tracking identifier 266 stored in the record is accurate.

The management interface server 122C includes a management interface engine 123 configured to generate a management interface, described below. The management interface engine 123 is configured to access (e.g., via an Application Programming Interface (“API”) or other suitable technique) the information stored in the tracking data store 125 and use the information to generate displays (e.g., graphs, charts, lists, reports, etc.) for the management interface.

The management interface engine 123 may include or communicate with web server components (not shown) configured to present conventional webpages displayable by conventional Internet browser applications executing on computing devices, such as a computing device 12 illustrated in FIG. 4 and described below. The management interface presented by the management interface engine 123 may include one or more web pages that may be transmitted by the web server components (not shown) to other computing devices in the system 100. Such web pages may be displayed by conventional Internet browser applications executing on the recipient computing devices.

As illustrated, the end user computing device 162A includes an reviewing application 214 and a web browser 218. In some embodiments, reviews may be submitted via the end user computing device 162A using the web browser 218 alone, and so the reviewing application 214 may not be present. The reviewing application 214 includes a tracking Software Development Kit (SDK) 216. The tracking SDK 216 includes functions and/or procedures that execute when selected events occur on the computing device 162A on which the application 214 is installed. For example, the developer of the reviewing application 214 may instruct the tracking SDK 216 to transmit review information to the tracking system 120 when a review is created within the reviewing application 214.

By way of a non-limiting example, the tracking SDK 216 may be implemented as a library file that is included in an application project used to create the application 214. An application developer may specify which particular functions are called from the library to indicate to the tracking engine 124 when install events, review submissions, and/or other in-application (“in-app”) events have occurred. As another non-limiting example, in some embodiments the functionality described herein as being provided by the tracking SDK 216 is not included in a library file that is included in the application project used to create the application 214, but is instead accessed by virtue of the application 214 performing remote function calls to an application programming interface (API) provided by the tracking engine 124 or other element of the tracking system 120.

FIG. 2 also includes a review web site server 192, an app store server 228, and a third-party web crawler server 230. As discussed above, the review web site server 192 may be any type of web site on which users post reviews. In some embodiments, the review web site server 192 may include integration software (similar to the tracking SDK 216 or calls to a similar API provided by the tracking server 122A) that allows the review web site server 192 to transmit review notifications directly to the tracking server 122A. In some embodiments, the web crawler engine 226 may scrape review information from the review web site server 192 without any integration software being added to the review web site server 192. The app store server 228 is similar to the review web site server 192, but instead of being operated by a third party, the app store server 228 may be operated by an application provider 170 or other entity that makes apps available for download and installation. The third-party web crawler server 230 may be any suitable third party server that extracts review information from review web sites 190 and makes their information available in a format usable by the tracking server 122A.

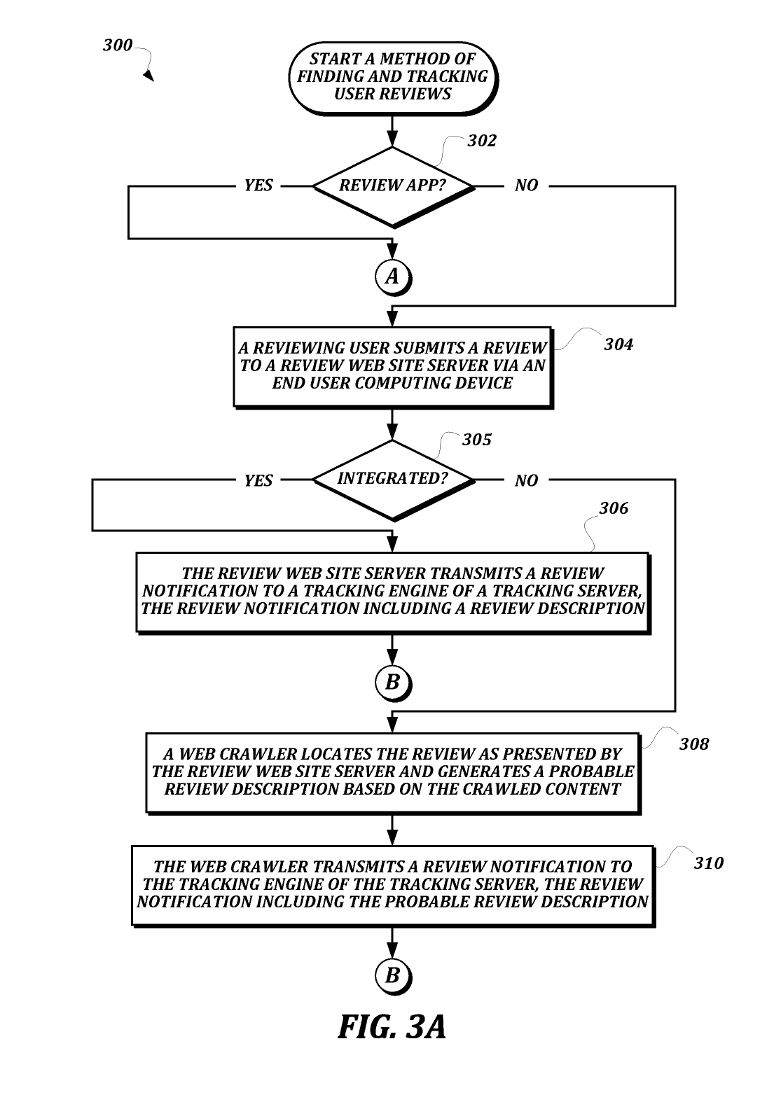

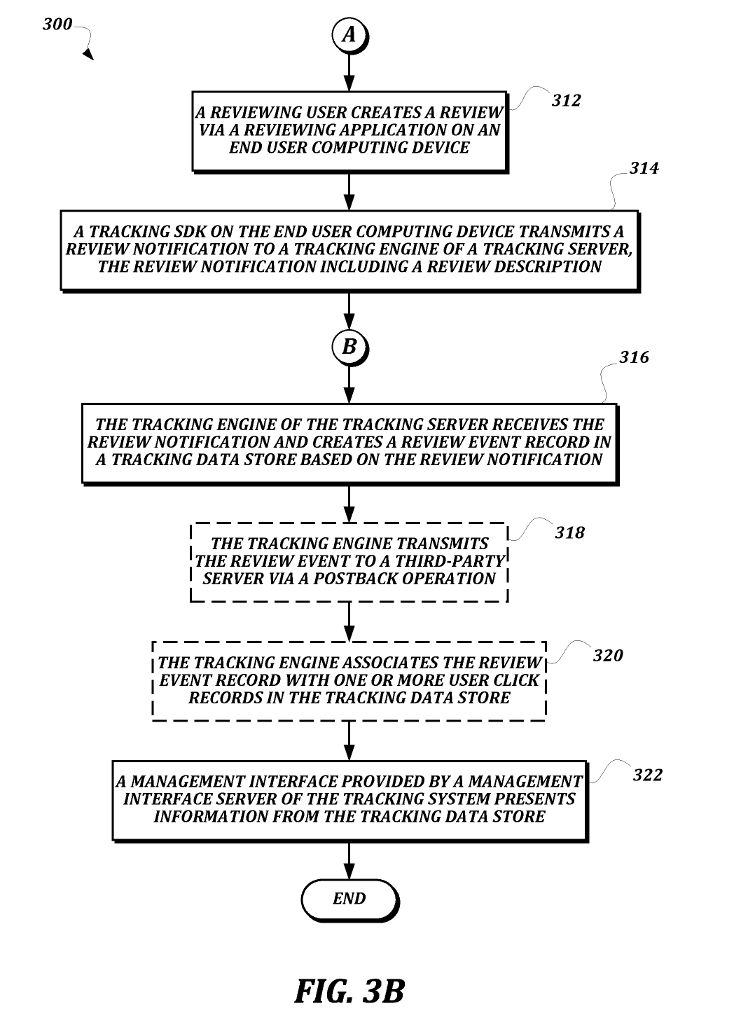

FIGS. 3A-3B are a flowchart that illustrates an exemplary embodiment of a method 300 of finding and tracking user reviews according to various aspects of the present disclosure. From a start block, the method 300 proceeds to a decision block 302, where the flow of the method 300 branches based on whether user reviews are being tracked for users that submit the reviews using an application 214 that directly reports review information to the tracking system 120. For applications 214 that directly report review information to the tracking system 120, then the YES branch at decision block 302 is followed, and the method 300 proceeds to a continuation terminal (“terminal A”).

From terminal A (FIG. 3B), the method 300 proceeds to block 312, where a reviewing user creates a review via a reviewing application 214 on an end user computing device 162A. In some embodiments, the reviewing application 214 is an app produced by a review web site 190, such as a Yelp app, a Hotels.com app, and/or the like. In some embodiments, the reviewing application 214 may be an app store application incorporated into an operating system of the end user computing device 162A that includes the tracking SDK 216. In some embodiments, a review may constitute an affinity indicator such as a “favorite,” a “like,” a “+1,” a retweet, and/or the like, and so the reviewing application 214 may be a social networking application that provides creation of such affinity indicators.

At block 314, a tracking SDK 216 on the end user computing device 162A transmits a review notification to a tracking engine 224 of a tracking server 122A, the review notification including a review description. In some embodiments, the review notification may include the tracking identifier 266 to facilitate matching of the review notification to the posting user or end user computing device 162A. The review description may also include information describing the content of the review, including but not limited to review text, an indicator of review polarity, a review quality rating, a timestamp, a verified purchaser indication, and/or the like. If the review description includes a match probability, the match probability of the review notification created at block 314 would be 100%, because the tracking SDK 216 is able to insert the matching tracking identifier 266 when creating the review notification, and the tracking SDK 216 can be configured to ensure that each element of the review notification accurately represents the corresponding portion of the submitted review. The method 300 then proceeds to a continuation terminal (“terminal B”).

Returning to the decision block 302 of FIG. 3A, if application 214 does not directly report review information to the tracking system 120, the NO branch at decision block 302 is followed and the method 300 proceeds to block 304. At block 304, a reviewing user submits a review to a review web site server 192 via an end user computing device 162A.

Since the application 214 did not directly report review information to the tracking system 120, a different technique must be used for the tracking system 120 to ingest the review. To that end, at decision block 305, the flow of the method 300 branches based on whether the review web site server 192 includes integration code for reporting review information to the tracking system 120. If the review web site server 192 does include integration code, then the YES branch at decision block 305 is followed, and the method 300 proceeds to block 306 where the review web site server 192 transmits a review notification to a tracking engine 224 of a tracking server 122A, the review notification including a review description. The review notification includes content similar to that discussed above, though if the review web site server 192 does not receive the tracking identifier 216 from the end user computing device 162A, the match probability may be omitted. In some embodiments, the review web site server 192 may create and transmit the review notification as part of a process for receiving and storing the review itself after the review is posted, while in some embodiments, the review web site server 192 may wait to create and/or transmit the review notification until a periodic batch transmission of multiple review notifications is performed. From block 306, the method 300 proceeds to terminal B.

Otherwise, the NO branch at decision block 305 is followed, and the method 300 proceeds to block 308, where a web crawler locates the review as presented by the review web site server 192 and generates a probable review description based on the crawled content. The web crawler may be the web crawler 226 of the tracking server 226 or the third-party web crawler server 230.

The review description is a “probable” review description because assumptions must be made by the web crawler regarding how to map crawled content to the structure of a review notification as consumed by the tracking engine 224. The web crawler may retrieve a semantic structure representing a review from the review web site server 192, and may search for fields in the structure that appear to match fields in the review notification. For example, the web crawler may search for fields named “user,” “userid,” “login,” and/or the like to attempt to fill a user field in the review notification, for fields named “text,” “reviewtext,” and/or the like to attempt to fill a review text field, for fields named “rating,” “stars,” and/or the like to attempt to fill a rating field, and so on. In some embodiments, the web crawler may be configured with specified mappings from fields in the semantic structure received from a given review web site server 192 to fields in the review notification.

In some embodiments, the web crawler may not receive any structured information from the review web site server 192 other than the web page text itself, and may attempt to reconstruct the semantic information itself, either by consulting a preconfigured template associated with the given review web site server 192 or by other means. In some embodiments, the web crawler may not extract the semantic information, but may instead include all retrieved information in the review notification so the tracking engine 224 may process it for semantic content. Because the web crawler may be attempting to map portions of the scraped review data with fields of the probable review description that are less than certain to match, the probable review description may include an accuracy probability for one or more fields (or for the probable review description as a whole).

At block 310, the web crawler transmits a review notification to the tracking engine 224 of the tracking server 122A, the review notification including the probable review description. If the web crawler 226 was used, the transmission from the web crawler 226 to the tracking engine 224 may be between engines executing on the same computing device. In some embodiments, further processing of the review information in the probable review description may be performed by the tracking engine 224. For example, the tracking engine 224 may fill in missing parts of the review description that were not identified by the web crawler, either by identifying the missing parts, or by inserting default or filler values. The method 300 then proceeds to terminal B.

From terminal B (FIG. 3B), the method 300 proceeds to block 316, where the tracking engine 224 of the tracking server 122A receives the review notification and creates a review event record 220 in a tracking data store 225 based on the review notification. If the review notification includes a probable review description with an accuracy probability below a minimum accuracy threshold, the review event record 220 (or the field that falls below the threshold) may not be created for the review notification.

At optional block 318, the tracking engine 224 transmits the review event to a third-party server via a postback operation. Block 318 is optional because in some embodiments, there are no third-party servers configured to receive the postback notifications. However, some third-party servers, such as application providers 170, may be particularly interested in receiving the review information. Receiving the review information would allow the application providers 170 to directly provide a reward within the application to the end user that submitted the review regardless of where and how the review was posted, and could therefore allow the application providers 170 to encourage the posting of more reviews. The content of the review event could also help the application providers 170 determine how their application is being received and to make changes in response to the feedback, if desired. In some embodiments, the review event transmitted to the third-party server may be stripped of user-identifying information, such as the tracking identifier 266, the device identifier, and/or the like, in order to protect the privacy of the user.

At optional block 320, the tracking engine 224 associates the review event record 220 with one or more user click records 222 in the tracking data store 225. To associate the review event record 220 with one or more user click records 222, the tracking engine 224 may determine a tracking identifier 266 to be stored in the review event record 220 by retrieving it from the review notification (if included), or by using information from the review description to attempt to match a tracking identifier 266 included in the user click records 222. If the tracking identifier 266 was not included in the review notification, then the review event record 220 may also include a match probability that indicates the likelihood that the tracking identifier 266 has been correctly assigned or uniquely identifies a given user.

As stated above, a user click record 222 may associated with a given user and can be used to attribute acquisition of the user and/or installation of the app to a given advertisement distributed by a given ad provider. Likewise, once a review event record 220 is associated with one or more user click records 222, this association can be used to provide credit (or to alter the amount of credit provided for user acquisition) to the entities identified by the user click records 222, wherein the amount of credit is based on the information in the review event record. For example, if a given user provides many reviews, positive reviews, or reviews that are found by other users to be particularly helpful, the given user may be particularly valuable and the amount of credit may be increased. As another example, if a given user provides negative reviews, low-quality reviews, or unhelpful reviews, then the amount of credit may be increased, or attributed entities may even be penalized for encouraging acquisition of the user. Block 320 is optional because, in some embodiments, the tracking and compilation of review information that occurs elsewhere in the method 300 may be valuable without needing to map the reviews to users.

The method 322 then proceeds to block 322, where a management interface provided by a management interface engine 223 of a management interface server 122C of the tracking system 120 presents information from the tracking data store 225. The information presented by the management interface engine 223 may include summary information for reviews attributed to a given ad provider, summary information for reviews generated as part of a given campaign regardless of ad provider or attribution, summary information for all reviews attributed to all ad providers, drill-down information for reviews posted by a given user, and/or any other suitable information based on the review records 220, the user click records 222, or any other information stored in the tracking data store 125. Though not illustrated, one of ordinary skill in the art will recognize that any suitable format may be used for presenting the information, including line graphs, bar graphs, area graphs, tabular formats, and/or any other suitable format.

The method 300 then proceeds to an end block and terminates.

As described above, the method 300 includes various decision points based on how reviews are tracked. One of ordinary skill in the art will recognize that the same tracking system 120 could execute all branches in the path for different situations, and may do so contemporaneously to collect review information from different sources.

### Computing Device

FIG. 4 is a diagram of hardware and an operating environment in conjunction with which implementations of the one or more computing devices of the system 100 may be practiced. The description of FIG. 4 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, smartphones, network-connected tablet computers, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 4 includes a general-purpose computing device in the form of the computing device 12. Each of the computing devices of FIG. 1 (including the computing devices 122, 132, 142, 152, 162, 172, and 192) may be substantially similar or identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface. The user interface is configured to display portions of the management interface 123 to appropriate users.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 4 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 300 illustrated in FIGS. 3A-3B) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The embodiments of the invention in which an exclusive property or privilege is claimed are defined as follows:

1. A computer-implemented method of tracking users who create reviews, the method comprising:
receiving, by a tracking engine executed by a tracking server, a review notification that includes user identifying information; and
creating, by the tracking engine, a review event record based on the review notification; and
storing, by the tracking engine, the review event record in a tracking data store.

2. The method as recited in claim 1, wherein the user identifying information of the review notification includes one or more of an IP address, a device identifier, and a user identifier.

3. The method as recited in claim 1, wherein the review notification is received by the tracking engine from a review web site server or an app store server.

4. The method as recited in claim 1, wherein the review notification is received by the tracking engine from a web crawler.

5. The method as recited in claim 4, wherein the review notification includes an match probability that indicates a likelihood that the user identifying information accurately identifies a given user.

6. The method as recited in claim 1, further comprising transmitting, by the tracking engine, a postback notification to a third-party server, the postback notification including the review event record.

7. The method as recited in claim 1, further comprising:
matching, by the tracking engine, the review event record to one or more user click records in the tracking data store; and
attributing, by the tracking engine, the review event record to one or more advertising providers associated with the one or more user click records.

8. The method as recited in claim 1, wherein the review notification includes review description information that comprises one or more of review text, a review polarity, a review quality rating, a timestamp, and a verified purchaser indication.

9. The method as recited in claim 1, where the review notification represents one or more of a text review, a star rating, an upvote/downvote, or an affinity indicator.

10. A computer-readable medium having computer-executable instructions stored thereon that, in response to execution by one or more processors of an end user computing device, cause the end user computing device to perform actions for tracking a user who submits a review, the actions comprising:
receiving, by a tracking SDK executing on the end user computing device, a notification that a review was created by the user;
generating, by the tracking SDK executing on the end user computing device, a review notification that includes user identifying information; and
transmitting, by the tracking SDK executing on the end user computing device to a tracking server, the review notification.

11. The computer-readable medium as recited in claim 10, wherein the end user computing device is a mobile computing device.

12. The computer-readable medium as recited in claim 10, wherein the tracking SDK is included in an application through which the review was created by the user.

13. The computer-readable medium as recited in claim 10, wherein the user identifying information of the review notification includes one or more of an IP address, a device identifier, and a user identifier.

14. A tracking system, comprising:
a tracking data store configured to store review event records; and
a tracking server configured to provide a tracking engine configured to:
receive a review notification that includes user identifying information;
create a review event record based on the review notification; and
store the review event record in a tracking data store.

15. The system as recited in claim 14, wherein the user identifying information of the review notification includes one or more of an IP address, a device identifier, and a user identifier.

16. The tracking system as recited in claim 14, wherein the tracking server further includes a web crawler configured to:
detect a review posted to a review web site server;
collect information from the review to create a review notification; and
transmit the review notification to the tracking engine.

17. The tracking system as recited in claim 16, wherein the review notification includes an match probability that indicates a likelihood that the user identifying information accurately identifies a given user.

18. The tracking system as recited in claim 14, further comprising:
a management interface server configured to present a management interface for analyzing review event records stored in the tracking data store.

19. The tracking system as recited in claim 14, wherein the tracking data store is further configured to store a plurality of user click records; and wherein the tracking engine is further configured to associate the review event record with one or more user click records of the plurality of user click records.

20. The tracking system as recited in claim 19, wherein the tracking engine is further configured to provide a reward to one or more advertising providers based on the associations between the review event record and the one or more user click records.

21. The tracking system as recited in claim 14, wherein the tracking engine is further configured to transmit a postback notification to a third-party server, the postback notification including the review event record.

22. The tracking system as recited in claim 14, wherein the review notification includes review description information that comprises one or more of review text, a review polarity, a review quality rating, a timestamp, and a verified purchaser indication.

23. The tracking system as recited in claim 14, where the review notification represents one or more of a text review, a star rating, an upvote/downvote, or an affinity indicator.
